(19) United States
(12) Patent Application Publication
(10) Pub. No.: US 2025/0165291 A1
(43) Pub. Date: May 22, 2025

(54) Deallocation Of Shared Memory Segments

(71) Applicant: Oracle International Corporation, Redwood Shores, CA (US)

(72) Inventors: Maurizio Cimadamore, Donabate (IE); Erik Österlund, Vasterhaninge (SE)

(73) Assignee: Oracle International Corporation, Redwood Shores, CA (US)

(21) Appl. No.: 18/582,043

(22) Filed: Feb. 20, 2024

Related U.S. Application Data
(60) Provisional application No. 63/602,218, filed on Nov. 22, 2023.

(51) Int. Cl. G06F 9/50; G06F 9/30

(52) U.S. Cl. CPC G06F 9/5022; G06F 9/3009; G06F 9/5033

(57) ABSTRACT

A system causes threads that are accessing shared memory segments of a memory region to terminate execution in preparation for deallocating the shared memory segments from the memory region and reclaiming the memory region. The system marks the memory region as closed and then instructs each thread to suspend execution. Responsive to determining that a thread was suspended during execution of a function that includes a memory access operation, the system causes the thread to execute, upon resuming execution, a thread-terminating instruction that terminates the thread. After the threads are terminated, the system deallocates the shared memory segments from the memory region and reclaims the memory region.

### INCORPORATION BY REFERENCE; DISCLAIMER

The following application is hereby incorporated by reference: application No. 63/602,218 filed on Nov. 22, 2023. The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to deallocation of shared memory segments. More particularly, the present disclosure relates to terminating threads that access shared memory segments prior to deallocating the shared memory segments.

### BACKGROUND

A system may initiate a memory region and may allocate a set of shared memory segments to the memory region. The shared memory segments may be accessed by various accessing threads. Subsequently, the system may close the memory region, deallocate the memory segments from the memory region, and reclaim the memory region. Proper termination of the threads that access the memory segments prior to deallocating the memory segments promotes system stability and prevents memory leaks.

The content of this background section should not be construed as prior art merely by virtue of its presence in this section.

### BRIEF DESCRIPTION OF THE DRAWINGS

The embodiments are illustrated by way of example and not by way of limitation in the figures of the accompanying drawings. References to “an” or “one” embodiment in this disclosure are not necessarily to the same embodiment, and they mean at least one. In the drawings:

FIG. 1 illustrates an example computing architecture that may be utilized to practice the techniques described herein;

FIG. 2 is a block diagram illustrating one embodiment of a computer system suitable for implementing methods and features described herein;

FIG. 3 illustrates an example virtual machine memory layout in block diagram form according to an embodiment;

FIG. 4 illustrates an example frame in block diagram form according to an embodiment;

FIGS. 5A and 5B are flowcharts that illustrate example operations pertaining to allocation and deallocation of shared memory segments; and

FIG. 6 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. ARCHITECTURAL OVERVIEW
   2.1 EXAMPLE CLASS FILE STRUCTURE
   2.2 EXAMPLE VIRTUAL MACHINE ARCHITECTURE
   2.3 LOADING, LINKING, AND INITIALIZING
3. ALLOCATING AND DEALLOCATING SHARED MEMORY SEGMENTS
4. HARDWARE OVERVIEW
5. MISCELLANEOUS; EXTENSIONS

### 1. General Overview

A system causes threads, that are accessing shared memory segments of a memory region, to terminate execution in preparation for deallocating the shared memory segments from the memory region and reclaiming the memory region. The system marks the memory region as closed and then instructs each thread of a set of threads that are accessing the memory region to suspend execution. The system then determines whether any of the set of threads were suspended during execution of a function that includes a memory access operation. Responsive to determining that a subset of one or more threads, of the set of threads, were suspended during execution of a function that includes a memory access operation, the system causes the subset of threads to execute, upon resuming execution, a thread-terminating instruction that terminates the thread. After the subset of threads are terminated by execution of thread-termination instruction, the system deallocates the shared memory segments from the memory region and reclaims the memory region. Any remaining threads that were not suspended during execution of a function that includes a memory access operation may self-terminate in response to determining that the memory region is marked as closed.

In one example, the system includes a provisioning thread, and a set of accessing threads, as further described below. The provisioning thread performs operations associated with initializing a memory region and allocating shared memory segments to the memory region. Additionally, the provisioning thread performs operations associated with deallocating the shared memory segments from the memory region and reclaiming the memory region. The accessing threads execute operations that include accessing the shared memory segments within a memory region initiated by the provisioning thread. The provisioning thread may initiate a process of reclaiming a memory region by marking the memory region as closed.

After the memory region is marked as closed, the provisioning thread instructs each accessing thread to suspend execution. The instruction to suspend execution may be submitted to an accessing thread via a synchronous handshake. The synchronous handshake may directly or indirectly cause each accessing thread to terminate upon resuming execution. In one example, when the accessing threads resume execution following suspension, a portion of the accessing threads may terminate as a result of the memory region having been marked as closed. Additionally, or in the alternative, the provisioning thread may provide a thread-terminating instruction to one or more of the accessing threads that causes the respective accessing thread to terminate upon resuming execution. In one example, the thread-terminating instruction may be submitted to an accessing thread via an asynchronous handshake. After providing the thread-terminating instruction and/or after each of the accessing threads have terminated, the provisioning thread may deallocate the shared memory segments from the memory region and may reclaim the memory region.

In one example, a thread-terminating instruction may be provided to accessing threads that were suspended during execution of a function that includes a memory access operation. An accessing thread may not necessarily terminate on its own when resuming execution of a function that includes a memory access operation. Additionally, an accessing thread that resumes execution of a function that includes a memory access operation may attempt to access a shared memory segment after the memory region has been marked closed. The attempt to access a shared memory segment after the memory region has been marked closed may interfere with the process of deallocating the shared memory segments and reclaiming the memory region. The thread-terminating instruction ensures that the accessing thread will terminate if the accessing thread resumes execution of a function that includes a memory access operation. By ensuring that the accessing thread will terminate, the provisioning thread prevents the accessing thread from attempting to access a shared memory segment region after the memory region has been marked closed.

One or more embodiments described in this Specification and/or recited in the claims may not be included in this General Overview section.

### 2. Architectural Overview

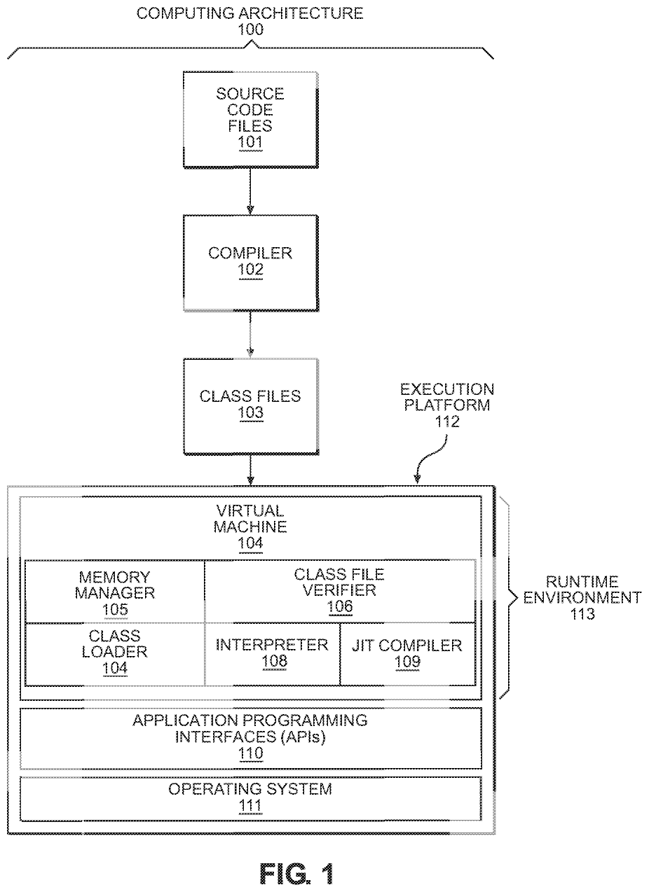

FIG. 1 illustrates an example architecture that may be utilized to practice the techniques described herein. Software and/or hardware components described with relation to the example architecture may be omitted or associated with a different set of functionalities than described herein. Software and/or hardware components, not described herein, may be used within an environment in accordance with one or more embodiments. Accordingly, the example environment should not be constructed as limiting the scope of any of the claims.

As illustrated in FIG. 1, a computing architecture 100 includes source code files 101 that are compiled by a compiler 102 into class files 103 representing the program to be executed. The class files 103 are then loaded and executed by an execution platform 112. The execution platform 112 includes a runtime environment 113, an operating system 111, and one or more application programming interfaces (APIs) 110 that enable communication between the runtime environment 113 and the operating system 111. The runtime environment 113 includes a virtual machine 104 that includes various components, such as a memory manager 105, a class file verifier 106, a class loader 107, an interpreter 108, and a just-in-time (JIT) compiler 109. The memory manager 105 may include a garbage collector. The class file verifier 106 may be utilized to check the validity of class files 103. The class loader 107 may be utilized to locate and build in-memory representations of classes. The interpreter 108 may be utilized to execute the virtual machine 104 code. The just-in-time (JIT) compiler 109 may be utilized to produce optimized machine-level code.

In an embodiment, the computing architecture 100 includes source code files 101 that contain code that has been written in a particular programming language, such as Java, C, C++, C#, Ruby, Perl, and so forth. Thus, the source code files 101 adhere to a particular set of syntactic and/or semantic rules for the associated language. For example, code written in Java adheres to the Java Language Specification. However, since specifications are updated and revised over time, the source code files 101 may be associated with and may adhere to a particular version of the specification. The exact programming language used to write the source code files 101 is generally not critical.

In various embodiments, the compiler 102 may convert the source code to machine or object code that is executable directly by the particular machine environment. Additionally, or alternatively, the compiler 102 may convert the source code to an intermediate representation (“virtual machine code/instructions”) such as bytecode that is executable by a virtual machine 104 running on top of the particular machine environment. The virtual machine instructions are executable by the virtual machine 104 in a more direct and efficient manner than the source code. Converting source code to virtual machine instructions includes mapping source code functionality from the language to virtual machine functionality that utilizes underlying resources, such as data structures. Often, functionality that is presented in simple terms via source code by the programmer is converted into more complex steps that map more directly to the instruction set supported by the underlying hardware that supports the virtual machine 104.

In general, programs are executed either as a compiled or an interpreted program. When a program is compiled, the code is transformed globally from a first language to a second language before execution. Since the work of transforming the code is performed ahead of time; compiled code tends to have excellent run-time performance. In addition, since the transformation occurs globally before execution, the code can be analyzed and optimized using techniques such as constant folding, dead code elimination, inlining, and so forth. However, depending on the program being executed, the startup time can be significant. In addition, inserting new code would require the program to be taken offline, re-compiled, and re-executed. For many dynamic languages (such as Java) that are designed to allow code to be inserted during the program's execution, a purely compiled approach may be inappropriate. When a program is interpreted, the code of the program is read line-by-line and converted to machine-level instructions while the program is executing. As a result, the program has a short startup time (can begin executing almost immediately), but the run-time performance is diminished by performing the transformation on the fly. Furthermore, since each instruction is analyzed individually, many optimizations that rely on a more global analysis of the program cannot be performed.

In some embodiments, the virtual machine 104 includes an interpreter 108 and a JIT compiler 109 (or a component implementing aspects of both), and executes programs using a combination of interpreted and compiled techniques. For example, the virtual machine 104 may initially begin by interpreting the virtual machine instructions representing the program via the interpreter 108 while tracking statistics related to program behavior, such as how often different sections or blocks of code are executed by the virtual machine 104. Once a block of code surpasses a threshold (is “hot”), the virtual machine 104 invokes the JIT compiler 109 to perform an analysis of the block and generate optimized machine-level instructions that replace the “hot” block of code for future executions. Since programs tend to spend most time executing a small portion of overall code, compiling just the “hot” portions of the program can provide similar performance to fully compiled code, but without the start-up penalty. Furthermore, although the optimization analysis is constrained to the “hot” block being replaced, there still exists far greater optimization potential than converting each instruction individually. There are a number of variations on the above-described example, such as tiered compiling.

To provide clear examples, the source code files 101 have been illustrated as the “top level” representation of the program to be executed by the execution platform 112. Although the computing architecture 100 depicts the source code files 101 as a “top level” program representation, in other embodiments the source code files 101 may be an intermediate representation received via a “higher level” compiler that processed code files in a different language into the language of the source code files 101. Some examples in the following disclosure assume that the source code files 101 adhere to a class-based object-oriented programming language. However, this is not a requirement to utilizing the features described herein.

In an embodiment, compiler 102 receives as input the source code files 101 and converts the source code files 101 into class files 103 that are in a format expected by the virtual machine 104. For example, in the context of the JVM, the Java Virtual Machine Specification defines a particular class file format and the class files 103 are expected to adhere to the particular class file format. In some embodiments, the class files 103 contain the virtual machine instructions that have been converted from the source code files 101. However, in other embodiments, the class files 103 may contain other structures as well, such as tables identifying constant values and/or metadata related to various structures (classes, fields, methods, and so forth).

The following discussion assumes that each of the class files 103 represents a respective “class” defined in the source code files 101 (or dynamically generated by the compiler 102/virtual machine 104). However, the aforementioned assumption is not a strict requirement and will depend on the implementation of the virtual machine 104. Thus, the techniques described herein may still be performed regardless of the exact format of the class files 103. In some embodiments, the class files 103 are divided into one or more “libraries” or “packages” that respectively include a collection of classes that provide related functionality. For example, a library may contain one or more class files that implement input/output (I/O) operations, mathematics tools, cryptographic techniques, graphics utilities, and so forth. Further, some classes (or fields/methods within those classes) may include access restrictions that limit their use to within a particular class/library/package or to classes with appropriate permissions.

### 2.1 Example Class File Structure

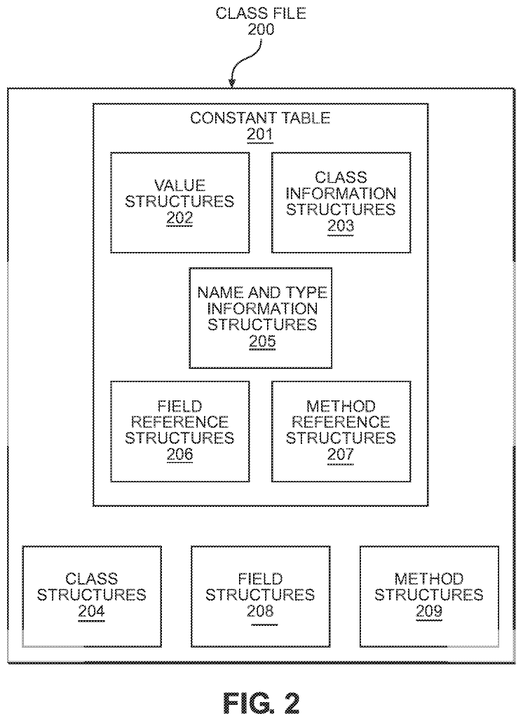

FIG. 2 illustrates an example structure for a class file 200 in block diagram form according to an embodiment. To provide clear examples, the remainder of the disclosure assumes that the class files 103 of the computing architecture 100 adhere to the structure of the example class file 200 described in this section. However, in a practical environment, the structure of the class file 200 will be dependent on the implementation of the virtual machine 104. Further, one or more features discussed herein may modify the structure of the class file 200 to, for example, add additional structure types. Therefore, the exact structure of the class file 200 is not critical to the techniques described herein. For the purposes of Section 2.1, “the class” or “the present class” refers to the class represented by the class file 200.

In FIG. 2, the class file 200 includes a constant table 201, field structures 208, class metadata 207, and method structures 209. In an embodiment, the constant table 201 is a data structure that, among other functions, acts as a symbol table for the class. For example, the constant table 201 may store data related to the various identifiers used in the source code files 101 such as type, scope, contents, and/or location. The constant table 201 has entries for value structures 202 (representing constant values of type int, long, double, float, byte, string, and so forth), class information structures 203, name and type information structures 204, field reference structures 205, and method reference structures 206 derived from the source code files 101 by the compiler 102. In an embodiment, the constant table 201 is implemented as an array that maps an index i to structure j. However, the exact implementation of the constant table 201 is not critical.

In some embodiments, the entries of the constant table 201 include structures that index other constant table 201 entries. For example, an entry for one of the value structures 202 representing a string may hold a tag identifying its “type” as string and an index to one or more other value structures 202 of the constant table 201 storing char, byte or int values representing the ASCII characters of the string.

In an embodiment, field reference structures 205 of the constant table 201 hold an index into the constant table 201 to one of the class information structures 203 representing the class defining the field and an index into the constant table 201 to one of the name and type information structures 204 that provides the name and descriptor of the field. Method reference structures 206 of the constant table 201 hold an index into the constant table 201 to one of the class information structures 203 representing the class defining the method and an index into the constant table 201 to one of the name and type information structures 204 that provides the name and descriptor for the method. The class information structures 203 hold an index into the constant table 201 to one of the value structures 202 holding the name of the associated class.

The name and type information structures 204 hold an index into the constant table 201 to one of the value structures 202 storing the name of the field/method and an index into the constant table 201 to one of the value structures 202 storing the descriptor.

In an embodiment, class metadata 207 includes metadata for the class, such as version number(s), number of entries in the constant pool, number of fields, number of methods, access flags (whether the class is public, private, final, abstract, etc.), an index to one of the class information structures 203 of the constant table 201 that identifies the present class, an index to one of the class information structures 203 of the constant table 201 that identifies the superclass (if any), and so forth.

In an embodiment, the field structures 208 represent a set of structures that identifies the various fields of the class. The field structures 208 store, for each field of the class, accessor flags for the field (whether the field is static, public, private, final, etc.), an index into the constant table 201 to one of the value structures 202 that holds the name of the field, and an index into the constant table 201 to one of the value structures 202 that holds a descriptor of the field.

In an embodiment, the method structures 209 represent a set of structures that identifies the various methods of the class. The method structures 209 store, for each method of the class, accessor flags for the method (e.g. whether the method is static, public, private, synchronized, etc.), an index into the constant table 201 to one of the value structures 202 that holds the name of the method, an index into the constant table 201 to one of the value structures 202 that holds the descriptor of the method, and the virtual machine instructions that correspond to the body of the method as defined in the source code files 101.

In an embodiment, a descriptor represents a type of a field or method. For example, the descriptor may be implemented as a string adhering to a particular syntax. While the exact syntax is not critical, a few examples are described below.

In an example where the descriptor represents a type of the field, the descriptor identifies the type of data held by the field. In an embodiment, a field can hold a basic type, an object, or an array. When a field holds a basic type, the descriptor is a string that identifies the basic type (e.g., “B”=byte, “C”=char, “D”=double, “F”=float, “I”=int, “J”=long int, etc.). When a field holds an object, the descriptor is a string that identifies the class name of the object (e.g., “L ClassName”). “L” in this case indicates a reference, thus “L ClassName” represents a reference to an object of class ClassName. When the field is an array, the descriptor identifies the type held by the array. For example, “[B” indicates an array of bytes, with “[” indicating an array and “B” indicating that the array holds the basic type of byte. However, since arrays can be nested, the descriptor for an array may also indicate the nesting. For example, “[L ClassName” indicates an array where each index holds an array that holds objects of class ClassName. In some embodiments, the ClassName is fully qualified and includes the simple name of the class, as well as the pathname of the class. For example, the ClassName may indicate where the file is stored in the package, library, or file system hosting the class file 200.

In the case of a method, the descriptor identifies the parameters of the method and the return type of the method. For example, a method descriptor may follow the general form “({ParameterDescriptor}) ReturnDescriptor”, where the {ParameterDescriptor} is a list of field descriptors representing the parameters and the ReturnDescriptor is a field descriptor identifying the return type. For instance, the string “V” may be used to represent the void return type. Thus, a method defined in the source code files 101 as “Object m (int I, double d, Thread t) { . . . }” matches the descriptor “(I D L Thread) L Object”.

In an embodiment, the virtual machine instructions held in the method structures 209 include operations that reference entries of the constant table 201. Using Java as an example, consider the following class:
class A
{
   int add12and13 ( ) {
      return B.addTwo (12, 13);
   }
}

In the above example, the Java method add12and13 is defined in class A, takes no parameters, and returns an integer. The body of method add12 and13 calls static method addTwo of class B that takes the constant integer values 12 and 13 as parameters, and returns the result. Thus, in the constant table 201, the compiler 102 includes, among other entries, a method reference structure that corresponds to the call to the method B.addTwo. In Java, a call to a method compiles down to an invoke command in the bytecode of the JVM (in this case invokestatic as addTwo is a static method of class B). The invoke command is provided an index into the constant table 201 corresponding to the method reference structure that identifies the class defining addTwo “B”, the name of addTwo “addTwo”, and the descriptor of addTwo “(I I) I”. For example, assuming the aforementioned method reference is stored at index 4, the bytecode instruction may appear as “invokestatic #4”.

Since the constant table 201 refers to classes, methods, and fields symbolically with structures carrying identifying information, rather than direct references to a memory location, the entries of the constant table 201 are referred to as “symbolic references”. One reason that symbolic references are utilized for the class files 103 is because, in some embodiments, the compiler 102 is unaware of how and where the classes will be stored once loaded into the runtime environment 113. As will be described in Section 2.3, eventually the run-time representations of the symbolic references are resolved into actual memory addresses by the virtual machine 104 after the referenced classes (and associated structures) have been loaded into the runtime environment and allocated concrete memory locations.

### 2.2 Example Virtual Machine Architecture

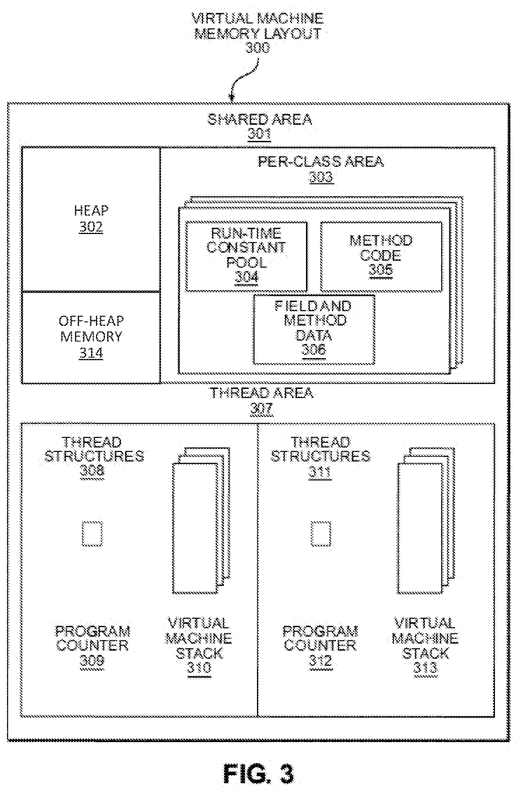

FIG. 3 illustrates an example virtual machine memory layout 300 in block diagram form according to an embodiment. To provide clear examples, the remaining discussion will assume that the virtual machine 104 adheres to the virtual machine memory layout 300 depicted in FIG. 3. In addition, although components of the virtual machine memory layout 300 may be referred to as memory “areas”, there is no requirement that the memory areas be contiguous.

In the example illustrated by FIG. 3, the virtual machine memory layout 300 is divided into a shared area 301 and a thread area 307. The shared area 301 represents an area in memory where structures shared among the various threads executing on the virtual machine 104 are stored. The shared area 301 includes a heap 302 and a per-class area 303. In an embodiment, the heap 302 represents the run-time data area where memory for class instances and arrays is allocated. In an embodiment, the per-class area 303 represents the memory area where the data pertaining to the individual classes are stored. In an embodiment, the per-class area 303 includes, for each loaded class, a run-time constant pool 304 representing data from the constant table 201 of the class, field, and method data 306 (for example, to hold the static fields of the class), and the method code 305 representing the virtual machine instructions for methods of the class.

The thread area 307 represents a memory area where structures specific to individual threads are stored. In FIG. 3, the thread area 307 includes thread structures 308 and thread structures 311, representing the per-thread structures utilized by different threads. To provide clear examples, the thread area 307 depicted in FIG. 3 assumes two threads are executing on the virtual machine 104. However, in a practical environment, the virtual machine 104 may execute any arbitrary number of threads, with the number of thread structures scaled accordingly.

In an embodiment, thread structures 308 includes program counter 309 and virtual machine stack 310. Similarly, thread structures 311 includes program counter 312 and virtual machine stack 313. In an embodiment, program counter 309 and program counter 312 store the current address of the virtual machine instruction being executed by their respective threads.

Thus, as a thread steps through the instructions, the program counters are updated to maintain an index to the current instruction. In an embodiment, virtual machine stack 310 and virtual machine stack 313 each store frames for their respective threads that hold local variables and partial results, and is also used for method invocation and return.

In an embodiment, a frame is a data structure used to store data and partial results, return values for methods, and perform dynamic linking. A new frame is created each time a method is invoked. A frame is destroyed when the method that caused the frame to be generated completes. Thus, when a thread performs a method invocation, the virtual machine 104 generates a new frame and pushes that frame onto the virtual machine stack associated with the thread.

When the method invocation completes, the virtual machine 104 passes back the result of the method invocation to the previous frame and pops the current frame off of the stack. In an embodiment, for a given thread, one frame is active at any point. This active frame is referred to as the current frame, the method that caused generation of the current frame is referred to as the current method, and the class that the current method belongs to is referred to as the current class.

Referring further to FIG. 3, in one example, the shared area may include the heap 302 and an off-heap memory 314. One or more memory regions may be located within the heap 302. Each memory region located in the heap 302 may include one or more shared memory segments that are accessible by a set of accessing threads. The off-heap memory 314 may include one or more memory regions located outside the heap 302. Each memory region located in the off-heap memory 314 may include one or more shared memory segments that are accessible by a set of accessing threads. In one example, the off-heap memory 314 and/or a memory region located in the off-heap memory 314 may be managed by an application or by a provisioning thread, for example, instead of the JVM. In one example, the off-heap memory 314 and/or a memory region located in the off-heap memory 314 may be utilized for non-managed data structures, such as large buffers, caches, or custom data models. Additionally, or alternatively, the off-heap memory 314 and/or a memory region located in the off-heap memory 314 may be utilized for data structures that exceed the capacity of the heap 302 and/or that require more efficient memory handling. Additionally, or alternatively, the off-heap memory 314 and/or a memory region located in the off-heap memory 314 may be utilized to provide interaction with native libraries or to provide direct memory access.

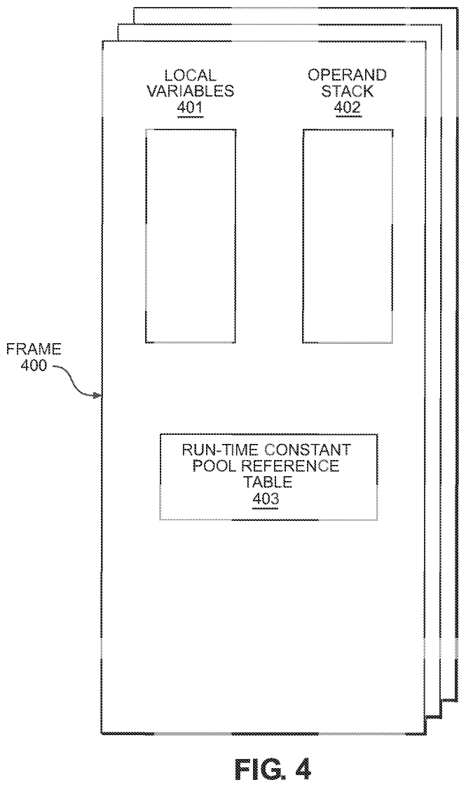

FIG. 4 illustrates an example frame 400 in block diagram form according to an embodiment. To provide clear examples, the remaining discussion will assume that frames of virtual machine stack 310 and virtual machine stack 313 adhere to the structure of frame 400.

In an embodiment, frame 400 includes local variables 401, operand stack 402, and run-time constant pool reference table 403. In an embodiment, the local variables 401 are represented as an array of variables that each hold a value, for example, Boolean, byte, char, short, int, float, or reference. Further, some value types, such as longs or doubles, may be represented by more than one entry in the array. The local variables 401 are used to pass parameters on method invocations and store partial results. For example, when generating the frame 400 in response to invoking a method, the parameters may be stored in predefined positions within the local variables 401, such as indexes 1-N corresponding to the first to Nth parameters in the invocation.

In an embodiment, the operand stack 402 is empty by default when the frame 400 is created by the virtual machine 104. The virtual machine 104 then supplies instructions from the method code 305 of the current method to load constants or values from the local variables 401 onto the operand stack 402. Other instructions take operands from the operand stack 402, operate on them, and push the result back onto the operand stack 402. Furthermore, the operand stack 402 is used to prepare parameters to be passed to methods and to receive method results. For example, the parameters of the method being invoked could be pushed onto the operand stack 402 prior to issuing the invocation to the method. The virtual machine 104 then generates a new frame for the method invocation where the operands on the operand stack 402 of the previous frame are popped and loaded into the local variables 401 of the new frame. When the invoked method terminates, the new frame is popped from the virtual machine stack and the return value is pushed onto the operand stack 402 of the previous frame.

In an embodiment, the run-time constant pool reference table 403 contains a reference to the run-time constant pool 304 of the current class. The run-time constant pool reference table 403 is used to support resolution. Resolution is the process whereby symbolic references in the constant pool 304 are translated into concrete memory addresses, loading classes as necessary to resolve as-yet-undefined symbols and translating variable accesses into appropriate offsets into storage structures associated with the run-time location of these variables.

### 2.3 Loading, Linking, and Initializing

In an embodiment, the virtual machine 104 dynamically loads, links, and initializes classes. Loading is the process of finding a class with a particular name and creating a representation from the associated class file 200 of that class within the memory of the runtime environment 113. For example, creating the run-time constant pool 304, method code 305, and field and method data 306 for the class within the per-class area 303 of the virtual machine memory layout 300. Linking is the process of combining the in-memory representation of the class with the run-time state of the virtual machine 104 so that the methods of the class can be executed. Initialization is the process of executing the class constructors to set the starting state of the field and method data 306 of the class and/or create class instances on the heap 302 for the initialized class.

The following are examples of loading, linking, and initializing techniques that may be implemented by the virtual machine 104. However, in many embodiments the steps may be interleaved, such that an initial class is loaded, then during linking a second class is loaded to resolve a symbolic reference found in the first class, thereby causing a third class to be loaded, and so forth. Thus, progress through the stages of loading, linking, and initializing can differ from class to class. Further, some embodiments may delay (perform “lazily”) one or more functions of the loading, linking, and initializing process until the class is actually required. For example, resolution of a method reference may be delayed until a virtual machine instruction invoking the method is executed. Thus, the exact timing of when the steps are performed for each class can vary greatly between implementations.

To begin the loading process, the virtual machine 104 starts up by invoking the class loader 107, and class loader 107 loads an initial class. The technique for specifying the initial class will vary from embodiment to embodiment. For example, one technique may have the virtual machine 104 accept a command line argument on startup that specifies the initial class.

To load a class, the class loader 107 parses the class file 200 corresponding to the class and determines whether the class file 200 is well-formed (meets the syntactic expectations of the virtual machine 104). If not, the class loader 107 generates an error. For example, in Java the error might be generated in the form of an exception that is thrown to an exception handler for processing. Otherwise, the class loader 107 generates the in-memory representation of the class by allocating the run-time constant pool 304, method code 305, and field and method data 306 for the class within the per-class area 303.

In some embodiments, when the class loader 107 loads a class, the class loader 107 also recursively loads the super-classes of the loaded class. For example, the virtual machine 104 may ensure that the super-classes of a particular class are loaded, linked, and/or initialized before proceeding with the loading, linking, and initializing process for the particular class.

During linking, the virtual machine 104 verifies the class, prepares the class, and performs resolution of the symbolic references defined in the run-time constant pool 304 of the class.

To verify the class, the virtual machine 104 checks whether the in-memory representation of the class is structurally correct. For example, the virtual machine 104 may check that each class except the generic class Object has a superclass, check that final classes have no sub-classes and final methods are not overridden, check whether constant pool entries are consistent with one another, check whether the current class has correct access permissions for classes/fields/structures referenced in the constant pool 304, check that the virtual machine 104 code of methods will not cause unexpected behavior (e.g. making sure a jump instruction does not send the virtual machine 104 beyond the end of the method), and so forth. The exact checks performed during verification are dependent on the implementation of the virtual machine 104. In some cases, verification may cause additional classes to be loaded, but does not necessarily require those classes to also be linked before proceeding. For example, assume Class A contains a reference to a static field of Class B. During verification, the virtual machine 104 may check Class B to ensure that the referenced static field actually exists, and as a result, Class B may be loaded, but not necessarily linked or initialized. However, in some embodiments, certain verification checks can be delayed until a later phase, such as being checked during resolution of the symbolic references. For example, some embodiments may delay checking the access permissions for symbolic references until those references are being resolved.

To prepare a class, the virtual machine 104 initializes static fields located within the field and method data 306 for the class to default values. In some cases, setting the static fields to default values may not be the same as running a constructor for the class. For example, the verification process may zero out or set the static fields to values that the constructor would expect those fields to have during initialization.

During resolution, the virtual machine 104 dynamically determines concrete memory address from the symbolic references included in the run-time constant pool 304 of the class. To resolve the symbolic references, the virtual machine 104 utilizes the class loader 107 to load the class identified in the symbolic reference (if not already loaded). Once loaded, the virtual machine 104 has knowledge of the memory location within the per-class area 303 of the referenced class and its fields/methods. The virtual machine 104 then replaces the symbolic references with a reference to the concrete memory location of the referenced class, field, or method. In an embodiment, the virtual machine 104 caches resolutions to be reused in case the same class/name/descriptor is encountered when the virtual machine 104 processes another class. For example, in some cases, class A and class B may invoke the same method of class C. Thus, when resolution is performed for class A, that result can be cached and reused during resolution of the same symbolic reference in class B to reduce overhead.

In some embodiments, the step of resolving the symbolic references during linking is optional. For example, an embodiment may perform the symbolic resolution in a “lazy” fashion, delaying the step of resolution until a virtual machine instruction that requires the referenced class/method/field is executed.

During initialization, the virtual machine 104 executes the constructor of the class to set the starting state of that class. For example, initialization may initialize the field and method data 306 for the class and generate/initialize any class instances on the heap 302 created by the constructor. For example, the class file 200 for a class may specify that a particular method is a constructor that is used for setting up the starting state. Thus, during initialization, the virtual machine 104 executes the instructions of that constructor.

In some embodiments, the virtual machine 104 performs resolution on field and method references by initially checking whether the field/method is defined in the referenced class. Otherwise, the virtual machine 104 recursively searches through the super-classes of the referenced class for the referenced field/method until the field/method is located, or the top-level superclass is reached, resulting in an error being generated.

### 3. Allocating and Deallocating Shared Memory Segments

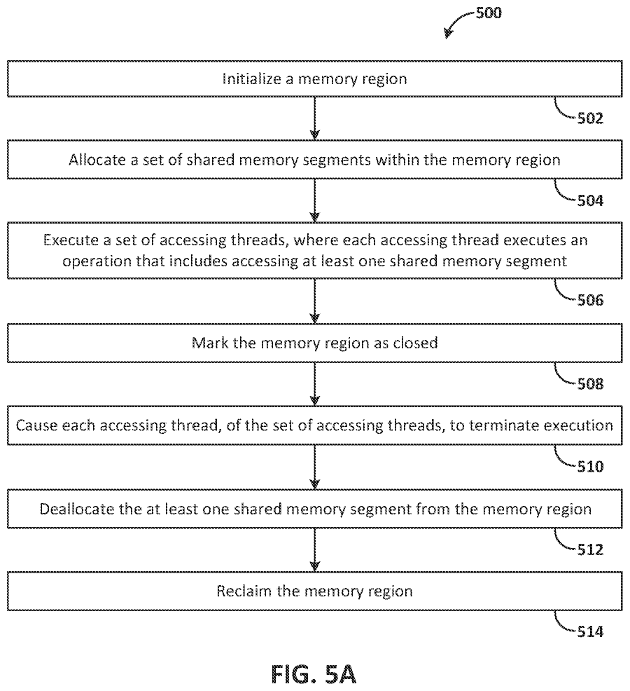

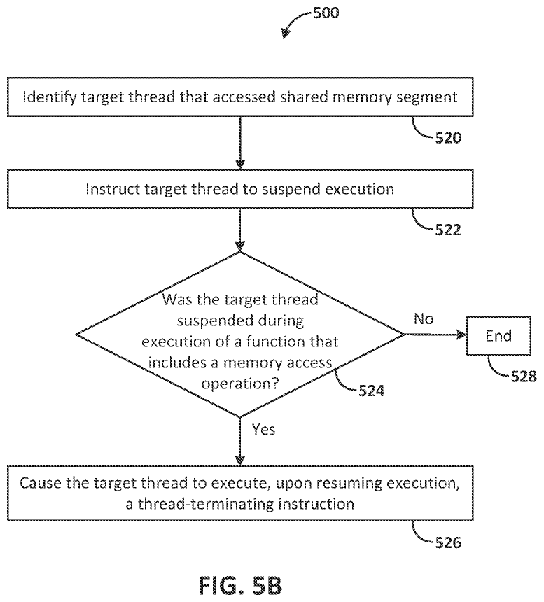

Referring now to FIGS. 5A and 5B, operations 500 pertaining to allocating and deallocating shared memory segments are further described. One or more operations 500 described with reference to in FIGS. 5A and 5B may be modified, combined, rearranged, or omitted all together. Accordingly, the particular sequence of operations 500 described with reference to FIGS. 5A and 5B should not be construed as limiting the scope of one or more embodiments.

As used herein, the term “provisioning thread” refers to a thread that performs operations associated with at least one of: initializing a memory region, allocating shared memory segments to the memory region, deallocating the shared memory segments from the memory region, or reclaiming the memory region.

As used herein, the term “accessing thread” refers to a thread, other than a provisioning thread, that executes one or more operations that include accessing a shared memory segment within a memory region.

Referring to FIG. 5A, the operations 500 may include, at block 502, initializing a memory region. In one example, an application may initialize a memory region at least by acquiring access to a contiguous portion of memory and defining the contiguous portion of memory as the memory region. The application may define a size or boundaries of the memory region. The memory region may be located in a shared area, such as in a heap or in an off-heap area.

The memory region may be initialized by an application, such as by a provisioning thread of the application. The application or the provisioning thread may utilize the memory region to execute various operations. Additionally, or alternatively, the provisioning thread may make the memory region available for one or more accessing threads to execute various operation. The operations executed by the accessing threads may pertain to one or more functionalities of the application or the provisioning thread that initialized the memory region. In one example, the memory region may be initialized during a start-up process for the application or the provisioning thread. Additionally, or alternatively, the memory region may be initialized prior to the application or the provisioning thread commencing execution of one or more primary functionalities.

At block 504, the operations 500 may include allocating a set of shared memory segments within the memory region. In one example, an application may allocate a set of shared memory segments within the memory region at least by invoking one or more allocation functions. The allocation functions may specify a size and location of the respective shared memory segments. Additionally, the allocation functions may generate and store references, pointers, or metadata related to the shared memory segments. The reference, pointers, or metadata may be utilized to track the location and utilization of the shared memory segments, and may be referred to when subsequently deallocating shared memory segments.

The shared memory segments may be respectively accessible by accessing threads associated with one or more functionalities of the application. In one example, each memory segment may be associated with a particular application or functionality. Additionally, or alternatively, a particular application or functionality may be associated with a particular memory segment. Multiple accessing threads may utilize a particular memory segment. At least a portion of the set of shared memory segments may be allocated when the memory region is initialized. Additionally, or alternatively, one or more of the shared memory segments may be allocated during execution of an application, such as for use in connection with a particular functionality of the application.

At block 506, the operations 500 may include executing a set of accessing threads. Each accessing thread, of the set of accessing threads, may execute one or more operations that includes accessing at least one shared memory segment of the set of shared memory segments. In one example, an accessing thread may generate and store one or more objects in a memory segment. The one or more objects may include serialized objects represented in a serialized format, such as a Java object serialization format. Additionally, or in the alternative, the one or more objects may include database records, file buffers, file streams, caches, cache entries, network communication objects, data processing objects, or computation objects. The objects may include one or more data structures, such as lists, arrays, data trees, graphs, queues, or thread-specific data structures. In one example, an accessing thread may utilize a pointer to access an object in a shared memory segment. Additionally, or alternatively, an accessing thread that generates and stores an object in a shared memory segment may generate a pointer to the object. The pointer to the object may be a shared pointer that allows other accessing threads to access the object. An accessing thread may read or modify an object in a memory segment in accordance with the operations executed by the accessing thread.

At block 508, the operations 500 may include marking the memory region as closed. By marking the memory region as closed, threads that have not yet accessed the memory region may be prevented from accessing the memory region. In one example, before accessing a memory segment, a thread may check whether the memory region is available or closed. When a thread that has not yet accessed a memory segment in the memory region determines that the memory region is marked as closed, the thread may refrain from attempting to access the memory segment. In one example, the thread may throw an exception upon determining that the memory region is closed, and the exception may cause the thread to terminate. Additionally, or alternatively, some threads that have already accessed a memory segment may again check whether the memory region is available or closed and may likewise terminate upon determining that the memory region is closed. Marking the memory region as closed may represent an initial step in a process of deallocating the memory segments from the memory region and reclaiming the memory region. The memory region may be marked as closed by the application or the provisioning thread that had initialized the memory region (e.g., at block 502). In one example, marking the memory region as closed may include updating an indicator associated with the memory region to indicate that the region is closed. The indicator may include a flag, a state variable, or metadata.

In one example, the application or the provisioning thread may mark the memory region as closed upon having completed execution of a set of operations. In one example, the memory region may have been initialized specifically for executing the set of operations and the memory region may be marked as closed upon having completed execution of the set of operations. Additionally, or alternatively, the application or the provisioning thread may mark the memory region as closed based on one or more memory management criteria and/or based on one or more programmatic criteria. The one or more memory management criteria may include completion of a set of operations, dynamic resource utilization parameters, or the memory region being no longer referenced by an application for which the memory region was initialized. The one or more programmatic criteria may include specific instructions to close the memory region upon reaching a certain state in a set of operations or upon completion of a process. Additionally, or alternatively, the application or the provisioning thread may mark the memory region as closed in response to an instruction form an external source, such as another application or a user input.

At block 510, the operations 500 may include causing each accessing thread, of the set of accessing threads, to terminate execution. In one example, at least a portion of the accessing threads may terminate on their own. Additionally, or in the alternative, the application or the provisioning thread may provide a thread-terminating instruction to at least a portion of the accessing threads that causes the accessing threads to terminate. Operations 500 pertaining to causing accessing threads to terminate execution are further described below with reference to FIG. 5B.

At block 512, the operations 500 may include deallocating the at least one shared memory segment from the memory region. Deallocating a shared memory segment may include identifying the shared memory segment and releasing or freeing the shared memory segment. The shared memory segments may be deallocated by invoking functions that correspond to the functions utilized to allocate the shared memory segments at block 504.

At block 514, the operations 500 may include reclaiming the memory region. Once all of the shared memory segments have been deallocated, the memory region can be reclaimed. Reclaiming the memory region may include releasing the memory region for future use. Additionally, or alternatively, reclaiming the memory region may include setting references, pointers, or metadata to indicate that the memory region is no longer in use.

Referring to FIG. 5B, the operations 500 pertaining to causing accessing threads to terminate execution (block 510 of FIG. 5A) are further described. The operations 500 described with reference to FIG. 5B may be performed for at least a portion of the accessing threads. As shown in FIG. 5B, the operations 500 may include, at block 520, identifying a target thread that accessed shared memory segment. As used herein, the term “target thread” refers to an accessing thread that is currently or has previously accessed a shared memory segment of a memory region that has been marked as closed, indicating that the memory region is about to be reclaimed. In one example, the application or the provisioning thread may identify a target thread at least by determining whether a thread accessed a shared memory segment that has been marked as closed. If the thread accessed a shared memory segment of a memory region that has been marked as closed, the thread may be designated as a target thread. The application or the provisioning thread may determine whether a thread accessed a shared memory segment by querying the thread's state or by inspecting the thread's stack trace.

At block 522, the operations 500 may include instructing a target thread to suspend execution. The system may instruct all or a portion of the target threads to suspend execution. In one example, target threads that are currently executing an operation that includes accessing a shared memory segment may be instructed to suspend execution. Additionally, or alternatively, target threads that have previously accessed a shared memory segment, or that could access a shared memory segment, may be instructed to suspend execution. The instruction to suspend execution may be submitted to a target thread via a synchronous handshake. The synchronous handshake may include a synchronization mechanism configured to coordinate or synchronize one or more operations between the provisioning thread and one or more target threads that receive the synchronous handshake.

A synchronous handshake may be initiated separately to each target thread. Additionally, or alternatively, a single synchronous handshake may be initiated that may be acted upon by a set of target threads. In one example, a synchronous handshake may be initiated by setting a flag that is monitored by the target thread(s), by sending a message to the target thread(s), or by invoking a method in the target thread(s) configured for the synchronous handshake. In one example, a synchronous handshake may enforce a sequential execution order. The sequential execution order may include the target thread(s) suspending execution, the provisioning thread examining the target thread(s) and/or providing the thread-terminating instruction, and the target thread(s) resuming execution. The synchronous handshake may be utilized to ensure a step-by-step interaction between the provisioning thread and the target thread(s).

In one example, as a result of the synchronous handshake(s), each target thread may be synchronously in a state of suspended execution. The synchronous state of suspended execution may be utilized to allow the application or the provisioning thread to evaluate the target threads, for example, to identify target threads that were suspended during execution of a function that includes a memory access operation, as described with reference to block 524 below. In one example, as a result of the synchronous handshake(s), each target thread may resume execution synchronously, for example, after evaluation of the target threads is completed.

The target thread(s) may communicate to the application or the provisioning thread an indication that the target thread(s) have suspended execution. The application or the provisioning thread may commence examining the target thread(s) and/or providing thread-terminating instructions upon receipt of communication that the target thread(s) have suspended execution. The application or the provisioning thread may communicate to the target thread(s) an instruction for the target thread(s) to resume execution. The instruction for the target thread(s) to resume execution may be submitted after the application or the provisioning thread has completed examining the target thread(s) and/or providing thread-terminating instructions. The instruction to resume execution may be part of the synchronous handshake or separate from the synchronous handshake. In one example, an instruction to resume execution may be submitted by way of a flag that is monitored by the target thread(s), or a message transmitted to the target thread(s).

A synchronous handshake may be utilized to ensure that the target thread(s) suspend execution at a specific point, for example, without abruptly terminating or causing inconsistent states. The synchronous handshake may include an instruction configured to cause the target thread(s) to suspend execution at a safepoint. Additionally, or alternatively, the target thread(s) may check for a synchronous handshake request upon reaching a safepoint. If a synchronous handshake request was initiated by the provisioning thread, the target thread(s) execute the one or more operations of the synchronous handshake at the safepoint. As used herein, the term “safepoint” refers to a synchronization barrier where an accessing thread can suspend execution safely. A safepoint may be located at a position in a set of executable operations that avoids non-interruptible operations. Additionally, or alternatively, a safepoint may be located at a position in the set of executable operations that avoids potential instabilities or inconsistencies that may arise as a result of suspending execution.

After the accessing threads have suspended execution, for example, in accordance with the synchronous handshake, the accessing threads may synchronously resume execution. One or more parameters or criteria for resuming execution may be defined by the synchronous handshake. Additionally, or in the alternative, the application or the provisioning thread may provide an additional instruction to cause the target threads to resume execution. The additional instruction to cause the target threads to resume execution may be submitted via an additional synchronous handshake.

In one example, a target thread, upon resuming execution, may determine whether the memory region is active or closed prior to executing an additional operation that would include accessing a shared memory segment in the memory region. Because the memory region was marked as closed (FIG. 5A, block 508), the target thread may determine that the memory region is marked as closed. In one example, responsive to determining that the memory region is marked as closed, the target thread may terminate. Additionally, or alternatively, the target thread may throw an exception in response to determining that the memory region is marked as closed, and in response to throwing the exception, the target thread may terminate.

In one example, a target thread that was suspended during execution of a function that includes a memory access operation may resume executing the function and/or may perform the memory access operation upon resuming execution. A target thread that executes, or attempts to execute, a memory access operation to access a shared memory segment after the memory region has been marked closed may interfere with the process of deallocating the shared memory segments and reclaiming the memory region. To prevent the target thread from executing, or attempting to execute a memory access operation, the application or the provisioning thread may provide a thread-terminating instruction to the target thread that causes the target thread to terminate upon resuming execution.

Thus, at block 524, the operations 500 may include determining whether the target thread was suspended during execution of a function that includes a memory access operation. The memory access operation may be for accessing the memory region that was marked as closed, at block 508 (FIG. 5A). Responsive to determining that the target thread was suspended during execution of a function that includes a memory access operation, the operations 500 may proceed to block 526. Alternatively, the operations 500 may end at block 528 in response to determining that the target thread was not suspended during execution of a function that includes a memory access operation. At block 526, the operations 500 may include causing the target thread to execute, upon resuming execution, a thread-terminating instruction. Causing the target thread to execute the thread-terminating instruction may be responsive to determining that the memory access operation is for accessing the memory region that was marked as closed, at block 508 (FIG. 5A). The synchronous handshake may directly or indirectly cause the target thread to terminate upon resuming execution. In one example, the thread-terminating instruction may include an instruction to throw an exception that causes the thread to terminate execution. The application or the provisioning thread may cause the target thread to execute the thread-terminating instruction in response to determining that the target thread was suspended during execution of a function that includes a memory access operation. The thread-terminating instruction may prevent the target thread from executing the memory access operation.

In one example, the synchronous handshake(s) may include an instruction configured to cause the application or the provisioning thread to execute one or more operations upon the target thread(s) reaching a state of suspended execution. The one or more operations may include determining whether a target thread was suspended during execution of a function that includes a memory access operation, for example, synchronously in response to the target thread(s) reaching a state of suspended execution. In one example, the synchronous handshake(s) may include an instruction configured to cause the target thread(s) to resume execution after the application or the provisioning thread executes one or more operations while the target thread(s) are in the state of suspended execution. The one or more operations may include examining a target thread during the state of suspended execution to determine whether the target thread was suspended during execution of a function that includes a memory access operation. Additionally, or alternatively, the one or more operations may include providing the thread-terminating instruction to the target thread.

In one example, determining whether the target thread was suspended during execution of a function that includes a memory access operation may include determining a function that the target thread was executing and determining whether the function includes a memory access operation. The function that the target thread was executing may be determined by querying the thread's state or by inspecting the thread's stack trace. The application or the provisioning thread may determine whether the function includes a memory access operation by examining the function or metadata associated with the function. In one example, a function that includes a memory access operation may be flagged with an indicator that indicates the presence of a memory access operation within the function. The indicator may be included in the function itself, or in metadata associated with the function. Additionally, or in the alternative, functions that include a memory access operation may be included in a table, and the application or the provisioning thread may determine whether the function includes a memory access operation by examining the table. In one example, the application or the provisioning thread may determine a function identifier corresponding to the function that the target thread was executing and determining whether the table includes the function identifier.

The application or the provisioning thread may determine that the target thread was suspended during execution of a function that includes a memory access operation at least by inspecting the target thread during a state of suspended execution. The memory access operation may include accessing a shared memory segment, for example, to generate an object in the shared memory segment or to interact with a shared object in the memory segment. The memory access instruction may represent a portion of an atomic operation. In one example, the atomic operation may include determining whether the memory region is active or closed, and either (a) executing the memory access operation, for example, in full, in response to determining that the memory region is active, or (b) refraining from executing the memory access operation in response to determining that the memory region is closed.

The thread-terminating instruction may be submitted via an asynchronous handshake. The asynchronous handshake may be initiated with respect to each target thread that was suspended during execution of a function that includes a memory access operation. A separate instruction may be submitted to each particular target thread, or a single instruction may be submitted that multiple target threads can act upon. In one example, an asynchronous handshake may be initiated by setting a flag that is monitored by the target thread(s), by sending a message to the target thread(s), or by invoking a method in the target thread(s) configured for the asynchronous handshake.

The target thread(s) may execute the thread-terminating instruction included in the asynchronous handshake upon resuming execution. In an embodiment, the asynchronous handshake is executed by the target thread(s) chronologically first upon resuming execution. The asynchronous handshake may be utilized to allow the target thread(s) to execute the thread-terminating instructions without coordination or direct response or acknowledgement from the application or the provisioning thread. The target thread(s) may execute the thread-terminating instruction as one or more independent operations that do not depend on further coordination from the application or the provisioning thread. Additionally, by utilizing an asynchronous handshake, the application or the provisioning thread may proceed with further operations, without waiting for a response or further coordination from the target thread(s). In one example, the further operations may include examining additional target thread(s) and providing additional asynchronous handshakes that include a thread-terminating instruction to target thread(s) that were suspended during execution of a function that includes a memory access operation.

In one example, the target thread(s) may execute the thread-terminating instruction based on one or more thread-terminating criteria. The provisioning thread may instruct the target thread(s) to evaluate a set of one or more thread-terminating criteria, and to execute the thread-terminating instruction in response to determining that the set of one or more thread-terminating criteria is satisfied. The one or more thread-terminating criteria may include determining whether the respective target thread, upon resuming execution, is executing a function that includes a memory access operation. If the target thread is not executing a function that includes a memory access operation, the target thread may refrain from executing the thread-terminating instruction. Additionally, or in the alternative, the one or more thread-terminating criteria may include determining whether the respective target thread, upon resuming execution, will terminate execution without executing the thread-terminating instruction. In one example, the target thread, upon resuming execution, may throw an exception and may terminate execution in response to throwing the exception. If the target thread will terminate execution without executing the thread-terminating instruction, the target thread may refrain from executing the thread-terminating instruction. In one example, the target thread may execute the thread-terminating instruction in response to determining that the target thread, upon resuming execution, (a) is executing a function that includes a memory access operation and (b) will not terminate execution without executing the thread-terminating instruction. In one example, whether the target thread will or will not terminate execution without executing the thread-terminating instruction may be time constrained. For example, the criteria for executing the thread-terminating instruction may include determining whether the target thread will terminate execution without executing the thread-terminating instruction within a specified time limit or time range. Additionally, or alternatively, whether the target thread will or will not terminate execution without executing the thread-terminating instruction may be operationally constrained. For example, the criteria for executing the thread-terminating instruction may include determining whether the target thread will terminate execution without executing the thread-terminating instruction prior to executing a memory access operation.

### 4. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

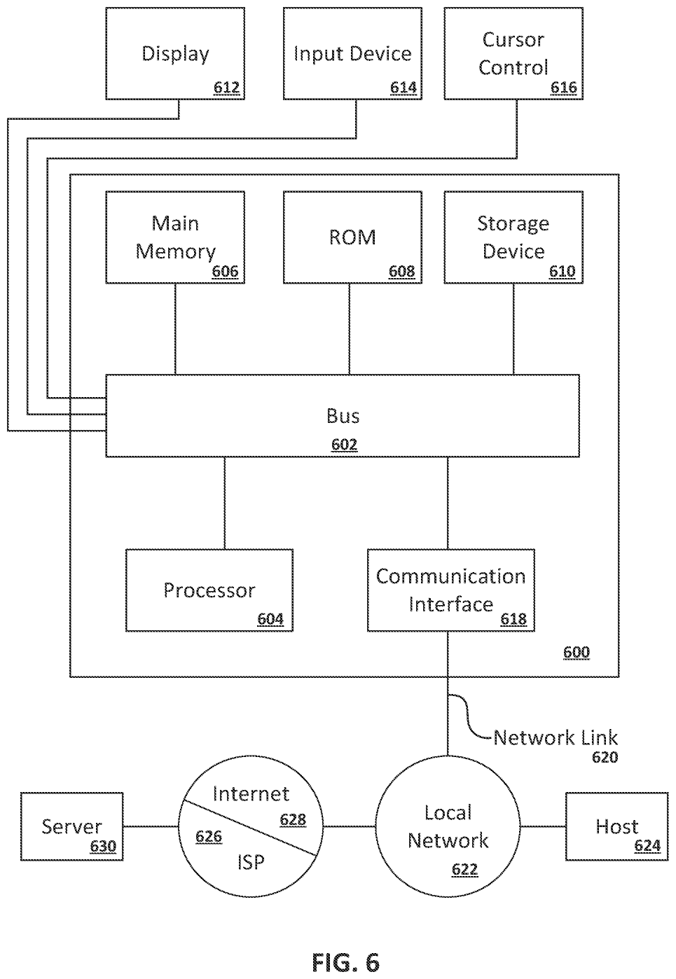

For example, FIG. 6 is a block diagram that illustrates a computer system 600 that may be utilized to implement the presently disclosed techniques. Computer system 600 may include a bus 602 or other communication mechanism for communicating information, and a hardware processor 604 coupled with bus 602 for processing information. Hardware processor 604 may be, for example, a general-purpose microprocessor.

Computer system 600 also may include a main memory 606, such as a random-access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 may further include a read-only memory (ROM) 608 or other static storage device coupled to bus 602 for storing static information and instructions for processor 604. A storage device 610, such as a magnetic disk or optical disk, is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic that, in combination with the computer system, causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media may include, for example, optical or magnetic disks, such as storage device 610. Volatile media may include dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media may include coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid-state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606. Processor 604 retrieves the instructions from main memory 606 and executes the instructions. The instructions received by main memory 606 may optionally be stored on storage device 610 either before or after execution by processor 604.

Computer system 600 also may include a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic, or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world-wide packet data communication network now commonly referred to as the “Internet” 628. Local network 622 and Internet 628 both use electrical, electromagnetic, or optical signals that carry digital data streams. Example forms of transmission media include the signals through the various networks that carry the digital data to and from computer system 600.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618. The code may be executed by processor 604 as and when received, and/or the code may be stored in storage device 610 or other non-volatile storage for later execution.

### 5. Miscellaneous; Extensions

Embodiments are directed to a system with one or more devices that include a hardware processor and that are configured to perform any of the operations described herein and/or recited in any of the claims below.

In an embodiment, a non-transitory computer-readable storage medium comprises instructions that, when executed by one or more hardware processors, causes performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of patent protection, and what is intended by the applicants to be the scope of patent protection, is the literal and equivalent scope of the set of claims that issue from this application, in the specific form that such claims issue, including any subsequent correction.

What is claimed is:

1. One or more non-transitory computer-readable media storing instructions that, when executed by one or more hardware processors, cause performance of operations comprising:
executing a first thread, wherein the first thread accesses at least one shared memory segment of a set of shared memory segments in a memory region;
marking the memory region as closed;
instructing the first thread to suspend execution;
responsive to determining that the first thread was suspended during execution of a function comprising a memory access operation: causing the first thread to execute, upon resuming execution, a thread-terminating instruction that terminates the first thread;
subsequent to the first thread being terminated, deallocating the at least one shared memory segment from the memory region;
reclaiming the memory region.

2. The one or more non-transitory computer-readable media of claim 1, wherein causing the first thread to execute the thread-terminating instruction is further responsive to determining that the memory access operation is for accessing the memory region.

3. The one or more non-transitory computer-readable media of claim 1,
wherein instructing the first thread to suspend execution comprises initiating a synchronous handshake,
wherein initiating the synchronous handshake comprises transmitting an instruction to suspend execution; and
wherein the first thread executes the instruction to suspend execution.

4. The one or more non-transitory computer-readable media of claim 3, wherein instructing the first thread to suspend execution comprises instructing the first thread to suspend execution at a safepoint.

5. The one or more non-transitory computer-readable media of claim 1,
wherein causing the first thread to execute the thread-terminating instruction comprises initiating an asynchronous handshake,
wherein initiating the asynchronous handshake comprises transmitting the thread-terminating instruction; and
wherein the first thread executes the thread-terminating instruction upon resuming execution.

6. The one or more non-transitory computer-readable media of claim 5, wherein the asynchronous handshake is executed by the first thread chronologically first upon resuming execution.

7. The one or more non-transitory computer-readable media of claim 1,
wherein the memory access operation comprises an atomic operation, wherein the atomic operation comprises either:
determining that the memory region is active and accessing the memory region; or
determining that the memory region is closed and refraining from accessing the memory region.

8. The one or more non-transitory computer-readable media of claim 1, wherein causing the first thread to execute, upon resuming execution, the thread-terminating instruction comprises:
instructing the first thread to evaluate a set of one or more thread-terminating criteria, and
executing the thread-terminating instruction in response to determining that the set of one or more thread-terminating criteria is satisfied.

9. The one or more non-transitory computer-readable media of claim 8, wherein the set of one or more thread-terminating criteria comprises at least one of:
upon resuming execution, the first thread is executing a function that includes a memory access operation;
upon resuming execution, the first thread will not terminate execution prior to executing the memory access operation without executing the thread-terminating instruction; or
upon resuming execution, the first thread will not terminate execution within a specified time limit without executing the thread-terminating instruction.

10. The one or more non-transitory computer-readable media of claim 1, wherein the first thread executes the thread-terminating instruction in response to determining that the first thread, upon resuming execution, (a) is executing a function that includes a memory access operation and (b) will not terminate execution prior to executing the memory access operation without executing the thread-terminating instruction.

11. The one or more non-transitory computer-readable media of claim 1, wherein determining that the first thread was suspended during execution of the function comprising an atomic operation comprises:
determining the function being executed by the first thread when execution of the first thread was suspended, and
determining whether the function includes a memory access operation.

12. The one or more non-transitory computer-readable media of claim 1, wherein the operations further comprise:
prior to marking the memory region as closed, executing a second thread, wherein the second thread accesses at least one shared memory segment of the set of shared memory segments in the memory region;
wherein subsequent to marking the memory region as closed, the second thread terminates execution in response to determining that the memory region is marked as closed.

13. The one or more non-transitory computer-readable media of claim 12, wherein the second thread was suspended during execution of a function that does not include a memory access operation, or wherein the second thread was suspended subsequent to execution of a function that includes a memory access operation.

14. The one or more non-transitory computer-readable media of claim 1, wherein the operations further comprise:
subsequent to marking the memory region as closed, executing a second thread,
wherein the second thread determines that the memory region is marked as closed, and
wherein the second thread terminates execution in response to determining that the memory region is marked as closed.

15. The one or more non-transitory computer-readable media of claim 1, wherein the operations further comprise:
determining that the memory region is no longer being utilized; and
marking the memory region as closed in response to determining that the memory region is no longer being utilized.

16. The one or more non-transitory computer-readable media of claim 1, wherein deallocating the at least one shared memory segment from the memory region is executed in response to determining that a set of threads, including the first thread, have terminated execution.

17. The one or more non-transitory computer-readable media of claim 16, wherein the operations further comprise:
instructing each thread, of the set of threads, to suspend execution at least by initiating a synchronous handshake with each thread,
wherein initiating the synchronous handshake comprises transmitting an instruction to suspend execution,
wherein initiating the synchronous handshake with each thread directly or indirectly causes each thread to terminate upon resuming execution.

18. The one or more non-transitory computer-readable media of claim 16, wherein the operations further comprise:
executing a provisioning thread, wherein executing the provisioning thread comprises:
determining that a second thread accessed the at least one shared memory segment;
responsive to determining that the second thread accessed the at least one shared memory segment: initiating a synchronous handshake, wherein the synchronous handshake enforces a sequential execution order, comprising:
the second thread suspending execution,
the provisioning thread determining, at least by examining the second thread, that the second thread was suspended during execution of a memory access operation, and
the provisioning thread transmitting an instruction to terminate execution of the second thread, and
the second thread resuming execution,
wherein, upon resuming execution, the second thread terminates execution responsive at least to the instruction to terminate execution.

19. A method, comprising:
executing a first thread, wherein the first thread accesses at least one shared memory segment of a set of shared memory segments in a memory region;
marking the memory region as closed;
instructing the first thread to suspend execution;
responsive to determining that the first thread was suspended during execution of a function comprising a memory access operation: causing the first thread to execute, upon resuming execution, a thread-terminating instruction that terminates the first thread;
subsequent to the first thread being terminated, deallocating the at least one shared memory segment from the memory region;
reclaiming the memory region;
wherein the method is performed by at least one device including a hardware processor.

20. A system, comprising:
at least one hardware processor;
wherein the system is configured to execute operations using the at least one hardware processor, the operations comprising:
executing a first thread, wherein the first thread accesses at least one shared memory segment of a set of shared memory segments in a memory region;
marking the memory region as closed;
instructing the first thread to suspend execution;
responsive to determining that the first thread was suspended during execution of a function comprising a memory access operation: causing the first thread to execute, upon resuming execution, a thread-terminating instruction that terminates the first thread;
subsequent to the first thread being terminated, deallocating the at least one shared memory segment from the memory region;
reclaiming the memory region.
